(19) United States
(12) Patent Application Publication
(10) Pub. No.: US 2011/0075262 A1
(43) Pub. Date: Mar. 31, 2011

(54) Asymmetric light diffuser and methods for manufacturing the same

(76) Inventors: Chao-Ying Lin, Jhonghe City (TW); Jen-Huai Chang, Pingjhen City (TW); Yung-Hsiung Cheng, Pingjhen City (TW)

(21) Appl. No.: 12/585,859

(22) Filed: Sep. 28, 2009

(51) Int. Cl. G02B 5/02; B29D 11/00

(52) U.S. Cl. 359/599; 264/1.6

(57) ABSTRACT

Asymmetric light diffuser and the methods for manufacturing the same are provided. The diffuser is preferably a transparent film made by a stress-stretch process. Particularly, a substrate doped with variant beads is formed as an anisotropic film layer after the stress-stretch process, so that the characteristics with birefringence and diffusion are incorporated. Further the asymmetric relief structure is formed on the surface of substrate by means of extrusion or co-extrusion process. A uniform light and anisotropic refraction can be formed through the diffuser, and even the partial polarization scattering can be formed due to the asymmetric refraction. The preferred embodiment of the diffuser includes a first step of preparing the mold for forming the basic surface structure of the asymmetric diffuser. Further, the substrate with surface micro-structure is formed by a roll-to-roll process. After that, the inside variant refractions and structure deformation are formed under the stress-stretch process.

### BACKGROUND OF THE INVENTION

1. Field of the Invention

The present invention relates to an asymmetric light diffuser and method for manufacturing the same, more particularly, to employ a stress-stretch process performed on a substrate with surface structure having beads, and to form a diffuser with characteristics of birefringence and asymmetric diffusion.

2. Description of Related Art

According to the conventional technology, backlight module is generally used for the light source of a plat displayer. The backlight module is usually equipped with light source, light guide, and at least one diffuser for averaging the light distribution. Since the light source of the backlight module can be implemented as an array of LEDs or plural light tubes, such as CCFL, a diffusing plate and a diffusing film are required to diffuse the light. For example, a direct-light backlight is a major light source used for a TFT LCD panel, and the light source may emit through the TFT LCD panel via the diffusing film for displaying.

Reference is made to FIG. 1 showing a schematic diagram of a conventional backlight module. A backlight module 10 includes a backlight source 12 formed by a plurality of light emitting sources. Generally, one side of the backlight source 12 has a reflection layer 11. The light passes through the display panel via a diffusion layer 13. The diffusion layer 13 is used to form a uniform back light from the backlight source 12. Moreover, the light may also pass through a polarizer (not shown in the diagram), and the polarizer is essentially used for transform the natural light to a polarized light for displaying.

Further, the backlight source can be implemented as the LCD array (20) shown in FIG. 2. This implement also needs the diffuser to spread the light.

Reference is further made to U.S. Pat. No. 7,213,933, which is published at May 8, 2007, made by the same applicant with the application of the present invention. In which, a direct type backlight module of diffuser plate and its manufacturing method thereof are disclosed. The surface of the diffuser plate has uneven cylindrical lens, by which the incident light is scattered to form a uniform backlight source of a LCD. The major manufacturing method of the diffuser includes a co-extrusion process to extrude resin, and a diffuser film is formed after cooling down. The uneven structure on the surface is formed as the co-extrusion process.

In order to accomplish the diffusion of the backlight source, some prior arts have provided the related technologies via the substrate's structure. U.S. Pat. No. 5,944,405, which is published at Aug. 31, 1999, has disclosed a light diffuser film. Refer to a cross-sectional diagram of the light diffuser film. The substrate includes a reflection layer 32 outside a light guide layer 31, light source 3, and transparent light diffusion layer 38. A lens layer 34 is disposed outside the light diffusion layer 38. Irregular structure 340 is formed between the uniform surface 310 of the light guide layer 31 and the light diffuser layer 38, and also formed between the light diffusion layer 38 and the uniform surface 370 of the lens layer 34. Thereby, the above-described structure is used to form the diffusion of light.

Furthermore, U.S. Patent Publication No. 2006/0204744, which is published at Sep. 14, 2006, has disclosed an anisotropic light-scattering sheet used for accomplish light diffusion through the substance inside a substrate. FIG. 4 shows the schematic diagram of the light-scattering sheet. The shown structure is of the anisotropic light-scattering sheet on a XY plane. The structure includes a continuous phase 42 and a dispersed phase 44, and these phases provide variant refractions of light. The variant refractions cause the scattering structure 44 along X axis, and the passing light can produce stronger scattering along the Y axis which is vertical to X axis.

### SUMMARY OF THE INVENTION

In order to produce a diffuser with higher diffuser efficiency, the present invention provides an asymmetric light diffuser and a method for manufacturing the same. In the manufacturing method of the diffuser, a stress-stretch process is used to make a transparent substrate having diffusing beads to have a birefringence characteristic. Further, the asymmetric and the relief surface micro-structure are formed on the surface of the substrate. Therefore, the light passing through the diffuser will be scattered uniformly by the substrate having the described anisotropic substances and the relief surface. More, some kinds of polarization scattering phenomena will be produced.

In the mainstream, the liquid crystal used for LCD and LCD TV is not luminous, additional backlight source is required to provide the displayer lighting. However, the luminance may decrease since a diffuser plate or diffuser film is added in the backlight module. In some cases, a brightness enhancement film (BEF) will be used for enhancing the luminance. The primary 1 function of the brightness enhancement film is to change the light-emitting view angle for enhancing the luminance.

To a normal observer of LCD, the vertical view angle is often more important than the horizontal view angle, so that the mentioned brightness enhancement film primarily confines the vertical view angle for more luminance. It is featured that a bigger variation can be obtained between the vertical and the horizontal view angles since the asymmetric film provided in the present invention is an anisotropic film which is modifiable based on requirement. For example, if the diffusivity of the vertical view angle is made larger, the uneven vision, such as MURA, often caused in the backlight module of LCD can be eliminated. Meanwhile, if the diffusivity of the horizontal view angle is made smaller, the luminance of the backlight module and the panel can be effectively increased. The described characteristic of non-axisymmetric diffusion can accomplish a high-luminance and high-diffusivity asymmetric light diffuser that the currently-sold diffuser can not achieve.

The provided asymmetric light diffuser can be particularly used to form a diffusing direction of the light based on requirement. According to the preferred embodiment, a first step in the manufacturing method is to prepare a mold for molding surface structure of the asymmetric light diffuser. The mold's surface structure is transfer-printing on the rolls to form the micro-structure, or alternatively the micro-structure can be directly formed by cutting using cutting tools. After that, the micro-structure can be used for the extrusion process.

In which, the extrusion process utilizes an extruding machine to put the granular plastic fiber or the like polymer material in a supply tank, and blending-refine and heat plastic material through screw rod, so as to form the substance after melting-homogenizing. The melting substance is then filtered out the impurities through a filter set or a porous plate. After that, the substance is continuously extruded via a shaper die after more blending-refining process. More, the continuous product can be produced after cooling and solidifying. In this extrusion process, the mold covered with the rolls or the rolls with micro-structure is also used, and to form varied kinds of micro-structure on the upper and lower surfaces of the substrate of the diffuser.

According to the preferred embodiment of the present invention, the stretchable transparent sphere-shaped, elliptic-shaped or fiber bar-shaped diffusing beads are already blended in to material in the extrusion process. Since the difference between the optical refraction of those transparent beads and the refraction of the substrate is bigger, the diffusivity is always higher. Exemplarily, the variation of refraction is about 0.06 to 0.45. The substrate with micro-structure is then under a roll-to-roll process, in which the plural sets of rolls are used to mold the surface structure from the rolls on the two surfaces of the substrate. The substrate is then under a stress-stretch process. One of the approaches is processed in an extrusion process and to deform the substrate and its inside diffusing beads by adjusting the rolling rates of the two sets of rolls. Another approach is to stretch the semi-product of the film having the micro-structure by a specific stretcher after the extrusion process. The claimed asymmetric light diffuser is then produced. In particular, the claim diffuser can be produced by adjusting the extrusion process and the stretch process according to the purpose of use and any requirement.

The structure of the light diffuser of the present invention preferably has a substrate, and a plurality of transparent high-polymer diffusing beads that can be aligned or deformed. In which, the substrate or the inside diffusing beads can be stretched and aligned if it reaches the temperature of softening glass after heating. The diffusing beads are blended into the substrate during the extrusion process for forming the substrate. The single or double surfaces of the substrate has asymmetric relief structure. The surface structure is formed through the extrusion process, or co-extrusion process accompanied with the stretch process.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of the conventional backlight module;

FIG. 2 shows a schematic diagram of the backlight source made by LED array of the prior art;

FIG. 3 is a cross-sectional diagram of the conventional light diffuser;

FIG. 4 shows a schematic diagram of the conventional anisotropic light scattering film;

FIG. 5 shows a schematic diagram of the light propagating through the medium with variant refractive index in every direction;

FIG. 6 shows a schematic diagram of the light propagating path through the surface with relief structure;

FIG. 7 is a schematic diagram of the light propagating through a conventional flat panel without diffusion;

FIG. 8 is a schematic diagram of a birefringence diffusion caused by the light propagating through an anisotropic medium;

FIG. 9 shows a schematic diagram of the diffusion caused by the light propagating through the anisotropic medium;

FIG. 10A is a diagram of the diffusion as the light propagating through a substrate without inside diffusing beads;

FIG. 10B is a diagram of diffusion as the light propagating through a substrate having surface structure and inside beads;

FIG. 11A and FIG. 11B show the patterns of the diffusers with surface structure provided by the present invention;

FIG. 12 shows an experimental diagram provided by the present invention;

FIG. 13 shows a flow chart of the method for manufacturing the diffuser of the present invention;

FIG. 14 shows a flow chart of the manufacturing method by rolling using upper and lower rolls of the present invention;

FIG. 15 is a diagram showing a machine table of the present invention;

FIG. 16 shows a schematic diagram of the embodiment of the multi-layer manufacturing method of the present invention;

FIG. 17 shows a comparative diagram between the embodiment of multi-layer diffuser using co-extrusion process and the currently-sold diffuser;

FIG. 18 shows the diffusing angles of the asymmetric diffuser along TD and MD directions of the present invention;

FIG. 19 is one of the structural diagrams of the light diffuser of the present invention;

FIG. 20 is another structural diagram of the light diffuser of the present invention.

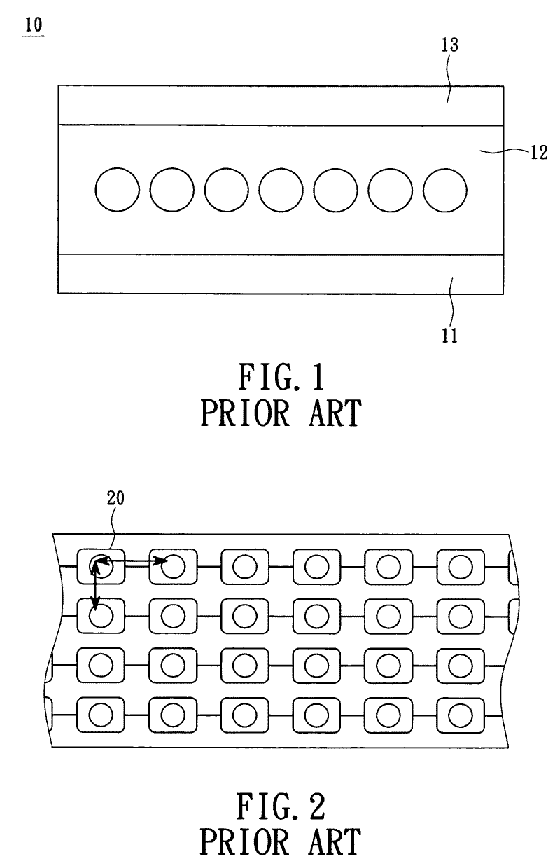

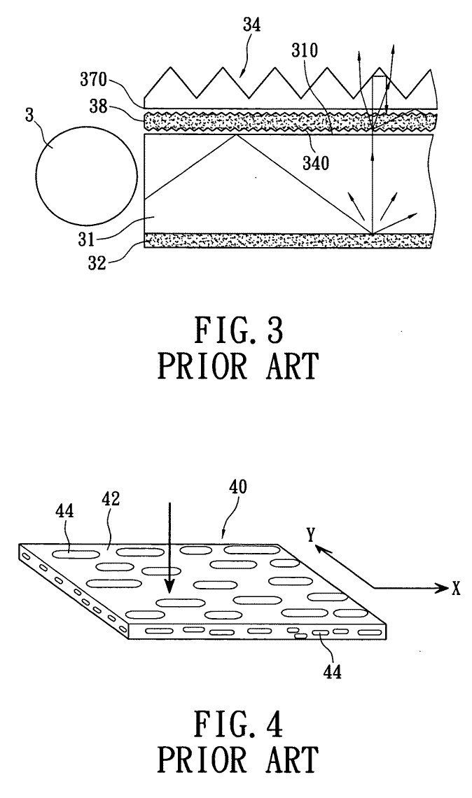

### DETAILED DESCRIPTION OF THE PREFERRED EMBODIMENTS

The present invention generally relates to an asymmetric light diffuser and its manufacturing method. The diffuser is particularly a device with better diffusivity, and essentially used for a backlight source of the display panel, such as a diffuser plate or diffuser film. The manufacturing method of the diffuser utilizes a stress-stretch process and its surface structure to make the diffusing beads have characteristic of birefringence with the substrate. Furthermore, the surface micro-structure with asymmetric relief is formed on the surface of the substrate. Therefore, the light emitted through the diffuser can be evenly scattered by the substrate having anisotropic material and its surface structure.

In particular, the refraction of the mentioned substrate and inside diffusing beads can be selected to be matching with the refraction of stretched film along a machine direction and a transverse direction. More, the thickness of the film is in accord with a requirement of constructive interference, such as a quarter wave. In this type of multi-layer film with stacked beads and substrate, the different directions of the emitting light can be polarized and reflected. A polarization scattering phenomenon occurs consequently. The related LCD panel has higher energy efficiency and higher luminance since the panel meets the strong polarized light. Otherwise, the traditional backlight source will consume more than half light intensity through the LCD panel and the polarization plate. Since the claimed film has effect of polarization scattering, the transmission rate and the luminance through the panel will be increased in a big range.

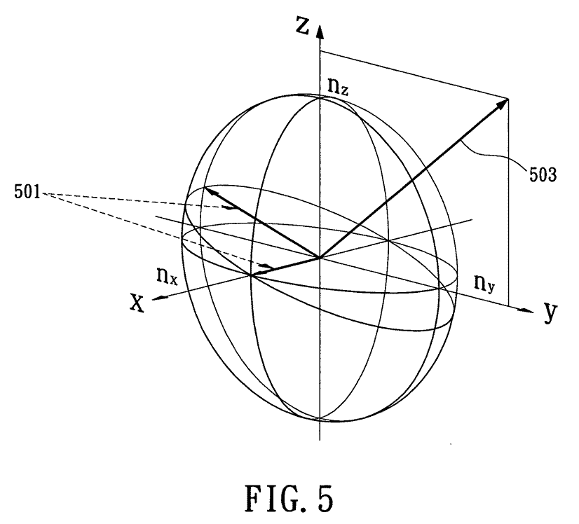

FIG. 5 shows a schematic diagram of the light propagating through the medium with variant refractive index in every direction. In which the light propagates through an anisotropic medium is shown. In the exemplary example shown in the diagram, the semi-ellipsoid depicts the light path in the medium. An x-axis, a y-axis and a z-axis describe three different directions in a coordinate of a 3-D space. The medium has three variant refractions, that are nₓ, n_{y} and n_{z}, in three directions. The direction 503 represents the path as the light propagates into the medium and forms an incident angle. Since every direction has its own refraction, the velocity of light also differs in each direction. Further, the light wave in each direction is polarized such as the Eigen polarization 501 shown in the figure.

Furthermore, the above-described physical property is introduced into the present invention. In the process for manufacturing the diffuser, the plural transparent beads are blended into the substrate. Therefore, the incident light will be refracted or polarized as the light passes through the diffuser. Alternatively, the high-polymer material is aligned by a stress-stretch process, the substrate and inside beads are deformed. The deformed substrate and the beads cause anisotropic refraction in every direction. The anisotropic physical property can accomplish better diffusivity and polarization.

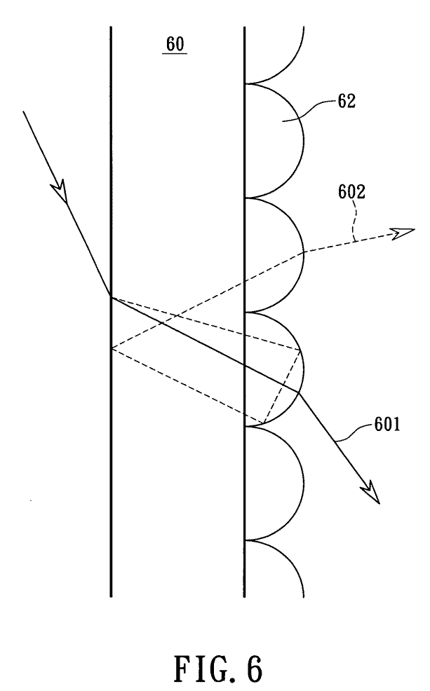

FIG. 6 shows a schematic diagram of a light propagating path through the surface with relief structure. When the light propagates into the diffuser, there are two light paths being generated due to the birefringence characteristic. The two light paths are respectively represented as a solid line 601 and a dotted line 602. In the current embodiment, the light enters a substrate 60 having birefringence characteristic, so the light is refracted into two separate light paths. The solid line 601 shows the light path as the light propagates to the surface structure 62 with relief structure. Since the refractive index changes, the direction of light is deflected. The dotted line 602 represents that the light enters the substrate 60 and deflects since the refractive index is variant.

The light then propagates to the surface structure 62. Because the refractive index between the materials is variant, the incident angle of light is refracted. The light may be reflected since its incident angle is bigger than a total reflective angle. Then the reflected light reaches the wall of the surface structure 62 and then being reflected back to the substrate 60 along another path. Finally the light is refracted out through the surface structure 62.

In the beginning, the light along both paths 601 and 602 enters the substrate 60, and the refractive angle, position, or direction has small variation. Then the difference between the light paths 601 and 602 becomes larger after the lens 62 with micro-structure changes the paths. The mentioned change is a very important feature in the present invention providing the high diffusivity. In which the effect of birefringence and the substrate with micro-structure make the diffusion of light stronger.

When the light propagates through the diffuser, the phenomena of refraction and reflection in every part differ with the design of the diffuser. If the diffuser has no surface structure, the diffusivity with birefringence merely shifts the light just as an oblique ray emitting through an optical flat glass. Although the light can be separated into two rays through the crystal with characteristic of birefringence, it has no difference with the angle of the two emitted light. Meanwhile, the characteristic of diffusion can not change the diffusing angle of the emitted light. More, the angular diffusivity may not increase even though the characteristic of birefringence increases the spatial diffusivity. That is, the capability of diffusion can not efficiently increase, nor change the angle after diffusion.

In view of above-described conditions, the embodiment of the present invention is to improve the shortcoming of the unchangeable angle of emitting light by means of the surface with micro-structure. The surface with micro-structure can efficiently change the emitting direction of the light, so as to increase the difference of the angle before and after diffusion. Therefore, the spatial and angular diffusivity of the diffuser can be obviously enhanced. Since the featured diffuser is applied to the LCD backlight source, the view angle of the LCD and the backlight source can be efficiently changed.

FIG. 7 shows an optical simulation of the light propagating through a conventional flat panel without diffusion. The pattern 70 shows an even light spot distributed on a XY plane, while the light passing through a substrate without any special design. The shown pattern is an even light spot or the isotropic diffusion phenomenon in every direction. The pattern 71 and the pattern 72 respectively show the illumination of the light projected along the Y and X direction, and the illumination in each direction is even.

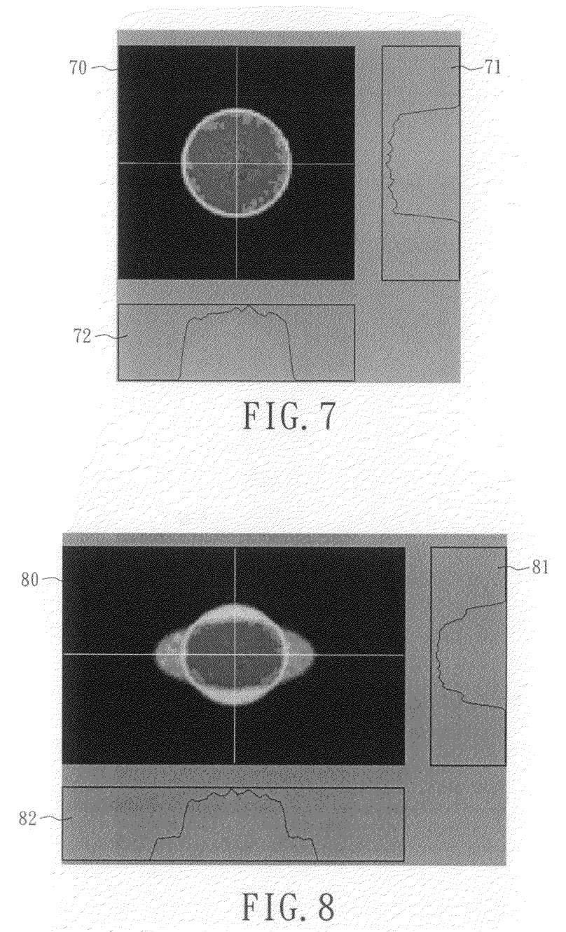

FIG. 8 is a diagram depicting distribution of light spots of a birefringence diffusion caused by the light propagating through an anisotropic medium. The calcite, sapphire, and quartz are the often seen crystals with characteristic of birefringence. By suitably modifying the direction of light axis of the crystal, the incident light is diffused by the birefringence medium. The related simulation of the diffusing phenomenon is shown in the pattern 80. The pattern 80 shows a diffusion phenomenon produced by a light spot. It is apparent to know that the diffusivity in the horizontal direction (the X) is larger than the vertical direction (the Y). Furthermore, the pattern 81 shows a distribution of illumination as the light spot diffusing along the Y direction as shown in pattern 80. Still further, the pattern 82 shows an illumination distribution as the light spot diffusing along the X direction of pattern 80. It is noted that the diffusivity along the X direction is larger.

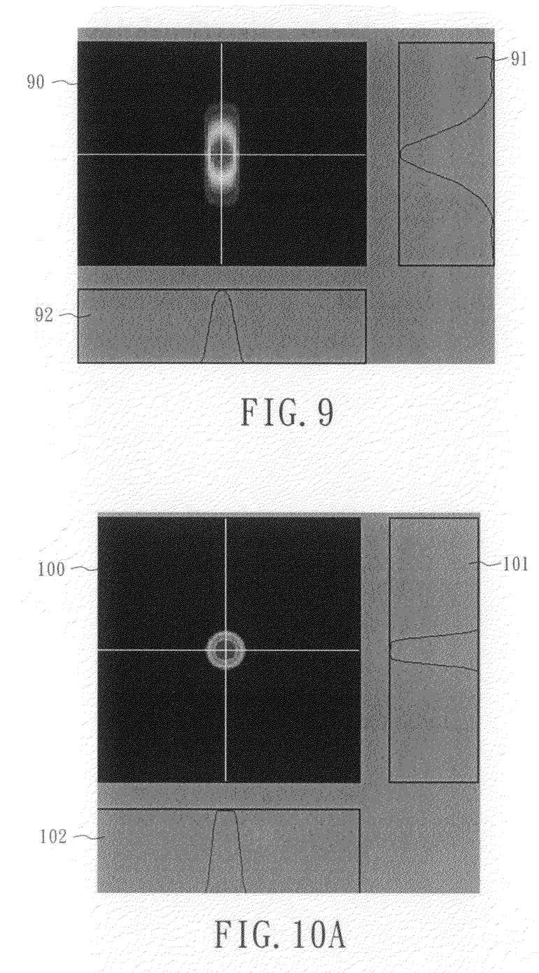

FIG. 9 shows an optical simulation of diffusion phenomenon caused by the light propagating through an asymmetric diffuser with bar-shaped micro-structure surface. The shown horizontal and bar-shaped micro-structure is parallel with the X-axis. The variety of the length and curvature of the micro-structure can be modulated by a stretch process. The anisotropic medium at least has two variant refractive indexes along two directions. The difference of the refractive indexes in the current case is 0.2. The pattern 90 shows the diffusion as the light propagates through the anisotropic medium. Moreover, the shown vertical and horizontal axes has a certain angle relationship with a specific axis, such as Y-axis referred to FIG. 5.

Since the medium that the light passes through has characteristic of anisotropy and the substrate has micro-structure surface, there is an obviously large diffusivity along the vertical direction. The pattern 91 shows an illumination projection on the vertical direction, and there is a larger angular diffusivity around the axis. According to the illumination projection shown in pattern 92 on the horizontal direction, the diffusivity is not larger than the previous case. Therefore, the optical difference caused by the asymmetric diffuser can be apparently changed or modified.

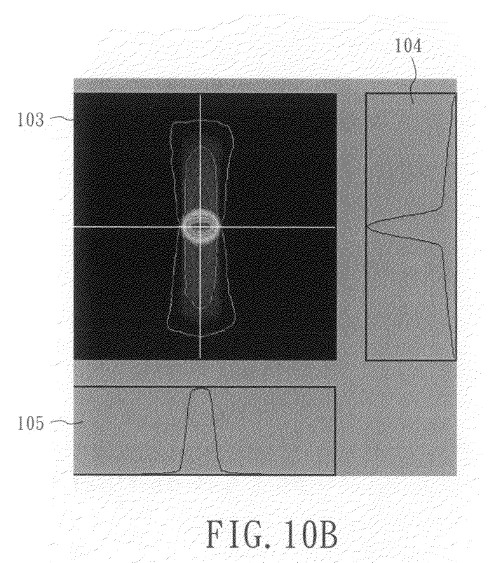

FIG. 10A is a diagram of the diffusion as the light propagating through a substrate without inside diffusing beads. The pattern 100 shows a smaller diffusion phenomenon since the light propagates through the medium without inside beads. The related distribution of illumination is confined to a small region. The patterns 101 and 102 show the angular illumination projections along two directions. It is similar to the distribution as the light passing through a transparent film since the related illumination distribution has no large angular diffusion.

FIG. 10B is a diagram of diffusion as the light propagating through a substrate having outside surface structure and inside beads. The inside beads under the mentioned stress-stretch process will be deformed. While the deformed beads are further under alignment, the diffusing beads will have anisotropic characteristic. The pattern 103 shows the obvious diffusion due to the light propagating through the medium under the same condition in FIG. 10A and further through the diffusing beads after the process of the stress-stretch process. The related illumination diffusion is distributed along the vertical direction.

Furthermore, the pattern 104 shows the illumination distribution which has obvious correlation with the doping concentration and the stretching proportion of the transparent beads, and the variation of the refraction. When the doping concentration of the bead is higher, the curvature representing light alignment will have larger distribution in a wide-angle region. However, the illumination distribution shown in FIG. 10A shows there is no wide-angular diffusion.

According to the embodiments of the present invention, the birefringence phenomenon shown in FIGS. 8, 9, 10A and 10B is essentially due to the light propagating through the asymmetric light diffuser. In a preferred embodiment, the substrate and the inside diffusing beads having birefringence characteristic are deformed by the stress-stretch process. In order to accomplish the diffusion, the surface of the diffuser can be formed with relief structure in another embodiment besides the above-described inside birefringence characteristic. The relief structure can scatter the incident light so as to implement the high diffusivity.

In a preferred embodiment, whether or not the beads in the diffuser having the anisotropic characteristic depends on how the substrate material and the diffusing beads collocated in the temperature under the stress-stretch process. Therefore the stretched birefringence variation and level of deformation are constrained by the design of manufacturing method. In some conditions, bar-shaped chinks or holes are formed between the substrate and the diffusing beads since the beads are not yet softened but being stretched already. In some other embodiments, the variant shapes of beads can be doped in the substrate of the diffuser, including the asymmetric elliptic beads, optical fibers, fibrous beads, and the bar-shaped beads such as glass fibers.

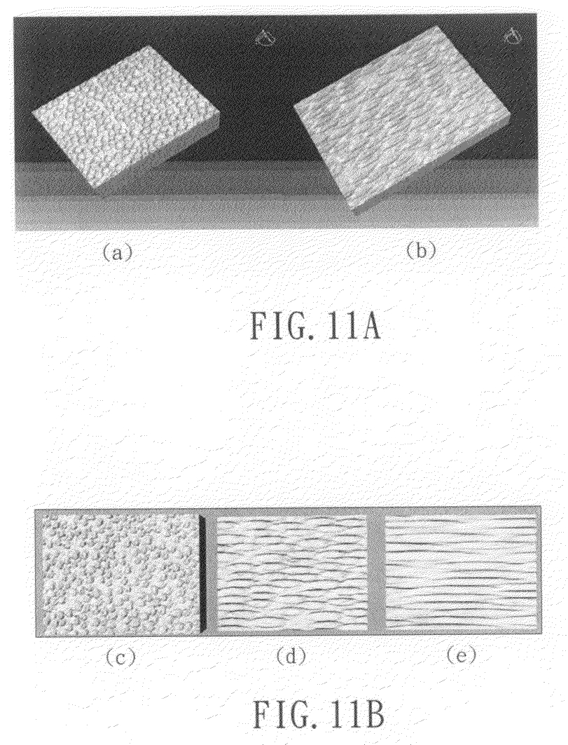

FIG. 11A and FIG. 11B show the patterns of the diffusers with surface structure provided by the present invention. Pattern (a) in FIG. 11A shows the surface structure of the diffuser after a molding process. Pattern (b) in FIG. 11A is the pattern of the surface structure after a further stretching process, and it shows a deformation more like an ellipse.

Further, pattern (c) in FIG. 11B shows the surface structure that keeps in the original condition and did not go through the stress-stretch process. The pattern (d) and pattern (e) show the variant stretching effects under different levels of stress forces. The surface structure has been deformed and produces variant anisotropic characteristics.

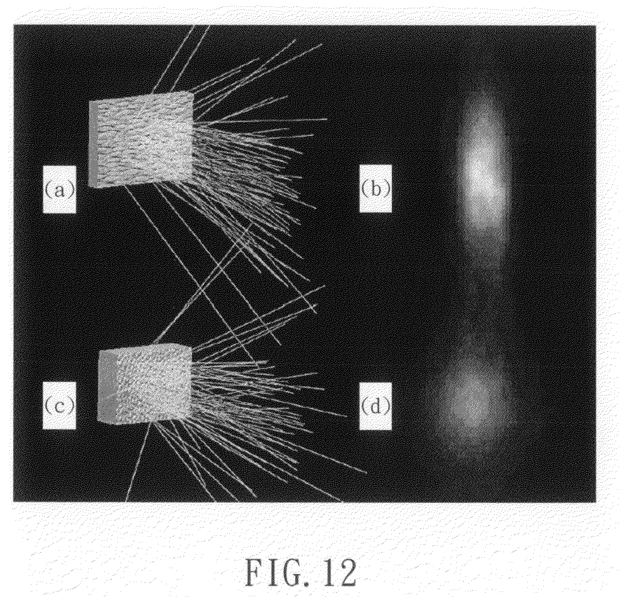

FIG. 12 shows an experimental diagram of an optical simulation provided by the present invention. The pattern (a) shows the diffusion phenomenon caused by the light propagating through an optical diffuser having the bar-shaped relief micro-structure with anisotropic characteristic. Particularly, the substrate of the optical diffuser has inside-doped diffusing beads which go through the stretch process. More, the pattern shows the condition of simulation as the diffuser under an extrusion process and stretch process. The surface of substrate is elliptic micro-structure.

Pattern (b) shows a light spot after diffusion along the vertical direction. The pattern (c) shows a condition as the light propagating through the optical diffuser whose substrate having doped transparent diffusing beads and circular relief surface micro-structure. While the diffuser is not yet under the stretch process and has no anisotropic characteristic, the diffusion pattern shows the micro-structure is circular form. It is a simulation as the diffuser under an extrusion process but not the stretch process.

Pattern (d) shows the diffusion phenomenon with no specific direction, but center on a region. This figure describes the variation of diffusion after the stretch process but not through the stretch process. The variation is made by the micro-structure under the stretch process besides the change of the diffuser's own refraction.

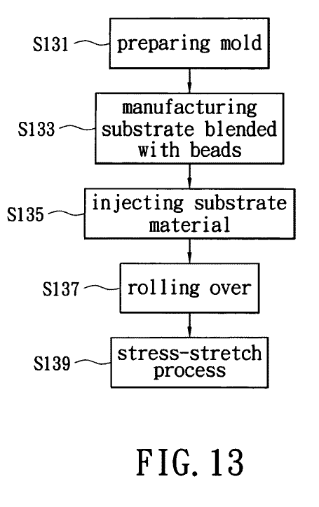

FIG. 13 illustrates the flow of the method for manufacturing the diffuser of the present invention. In step S131, a mold is prepared firstly. By means of the mold, the surface structure of the diffuser can be made by rolling over. The relief texture on the mold's surface can be made by a spraying method that sprays particles on the surface. More, a laser work can be used to form the relief texture on the surface. Alternatively, the cutting tool, such as diamond knife, can be mechanically used to mold the texture on rolls or on the surface of mold.

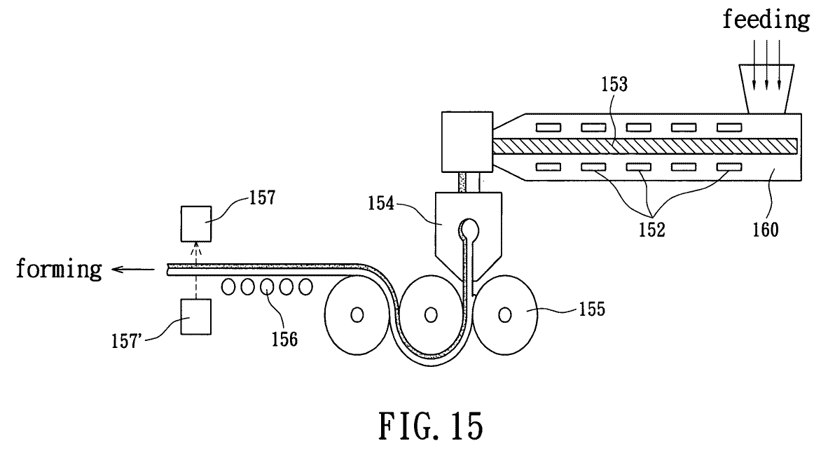

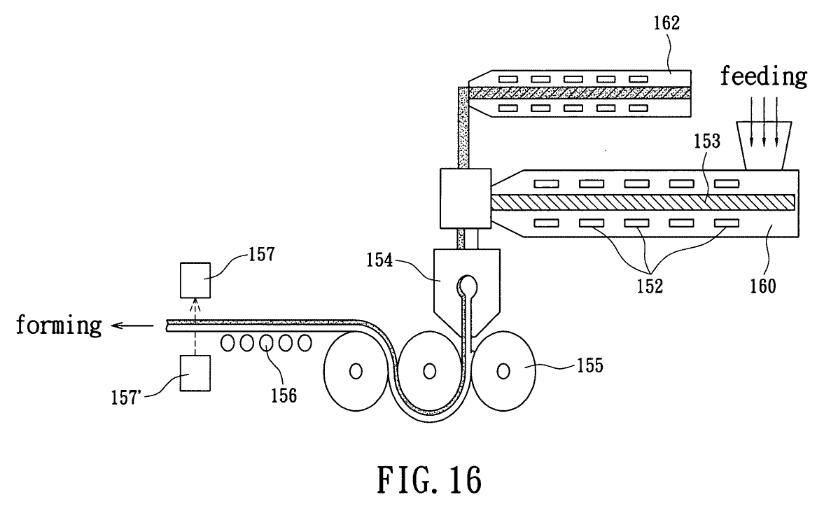

Next, the step in the method is to prepare a substrate material. In the preferred embodiment of the present invention, a blending-refine process is essentially used to make the substrate. In the process, the flexible beads can be blended in the material and perform the blending-refine or mastication process (step S133). The references can be made to FIG. 15 and FIG. 16 showing the schematic diagram of the machine table for the manufacturing method. In which, the substrate material being poured in a primary feeding region 160 or a secondary feeding region 162 is blended with the beads. Mostly, the material of the substrate or beads are thermoplastic high-polymer, such as at least one or in combination of the groups selected from Poly (Methyl methacrylate, PMMA), Polycarbonate (PC), Methyl methacrylate Styrene (MS), PolyStyrene (PS), Poly Ethylene Terephthalate (PET), Poly Ethylene Naphthalate, and Polypropylene (PP).

In the beginning step, the materials are under a dust removing process and a drying-baking process. Then the materials are going through a blending-refine and a mastication processes. The polymer under the blending-refine process is usually required to be melting by heating. A shearing effect caused by the blending-refine process will produce high temperature, so it needs to notice the cracking problem to the materials as over heating. In particular, some suitable processing agent or modification agent can be added into the materials to enhance the mechanical or thermal characteristics as performing the blending-refine process.

More, the blending-refine procedure is used to blend the materials adequately by Hunschel Mixer, Ribbon Mixer, or rolling mixer. After that, a mastication machine is then to masticate the materials so as to gelatinize the high-polymer. After the blending-refine process, the copolymer is then going through a filter, and to control the extrudate by a gear wheel. According to the design of feeding channel and the related integration, the film or diffuser substrate with different material and different thickness can be made by a Co-extrusion process. In the present invention, the diffusing beads can be doped into a specific film layer, or into a multi-layer substrate with different materials of the diffusing beads. Reference is made to FIG. 16.

At last, the melting high-polymer material high-polymer is split into multiple layers by a flow splitter, and outputted from the mold's head by continuous the co-extrusion procedure (step S135). The mold's head, such as T-die (154), functions to uniform the temperature and thickness of the plastic after the extrusion process, and to control the extrudate and film's size as in extrusion. Meanwhile, the thickness can be adjusted by modulating the space and extrudate of the rolls (155). For example, the thickness of the optical film and the substrate is usually 50 um to 3000 um.

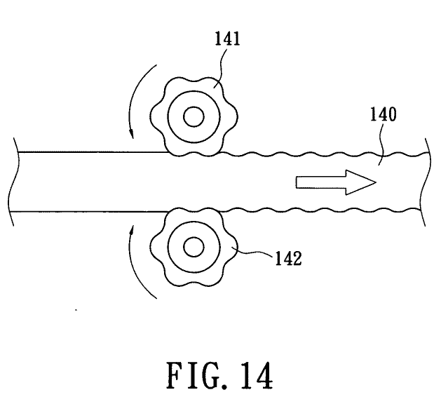

A flow of the co-extrusion procedure in the manufacturing method, which is referred to FIG. 14, is implemented by rolling over using upper and lower rolls. The shown rolls 141 and 142 are used to form the structure on the surfaces above and below the substrate. The extrusion procedure can rapidly to produce large-area diffusing film and substrate.

Reference is made to FIG. 15, which shows a diagram of a machine table of the present invention. While, the high-polymer material doped with the diffusing beads go through the primary feeding region 160. In the current case, a screw rod 153 and a heater 152 disposed on the feeding region are used to blend the materials. Through the extrusion procedure by the mold's head 154, the surface structure for the substrate, not yet solidified and cooling down, is formed by roll-to-roll process using rolls 155, especially by molding the surface texture of the rolls 155 on the surface of the substrate (step S137). In which, only one set of rolls is required to be arranged on the machine table if only one surface of the material needs to be formed the surface structure. Further, if both above and below surfaces are required to form the surface structure, two or more sets of smooth or textured rolls are employed to mold the patterns on the surfaces. The extrusion procedure still includes a step of cooling and solidifying the substrate by the shown plate 156, and a final step of examining the product by the examination devices 157 and 157′. The examination is provided to examine whether the thickness and diffusivity of the diffusing device meet the requirements or not.

Next, the stress-stretch process is used to stretch the materials and beads shown in FIG. 15 of the present invention. It is essentially to deform and change the refractive indexes the surface of micro-structure and the diffusing beads. The deformation of the beads is related to the work temperature in the procedure. The temperature is also dominate the changes of refractive indexes (step S139). The deformation can make the beads having alignment, and not be disorder and without a stable characteristics.

For example, the stress-stretch process can modify the variation of rolling rates of the rolls 155, so as to make the beads under variant stress forces. Meanwhile, the beads and the material will be stretched and produce the deformation and the changes of the refractive index. Particularly, the stress-stretch process can be used to form the stretch along the vertical or horizontal direction, and also make single-axis or multi-axis stretch. The proportion of the stretching changes in accordance with the design and characteristics of materials. The mentioned proportion is about 1.1 to 12. The often-seen proportion of the refractive index before and after the stretch process to the high-polymer material is 0.01 to 0.45. After that, a thermal treatment is often used to decrease and eliminate the remaining of inner stress as stretching.

Further reference is made to FIG. 16, which shows a schematic diagram of the embodiment of the multi-layer manufacturing method of the present invention. A multi-layer extrusion process is particularly used to form a multi-layer substrate. As shown in the diagram, the materials 161, 162 and 163 are used to form the multiple layers via different feeding regions. In the preferred embodiment, the materials are separately fed via the primary feeding region 160 and the secondary feeding region 162. The materials have high selectivity. The material in each layer can be different. In a specific layer, the transparent diffusing beads are doped. Further, the materials are simultaneously under the blending-refine process on the feeding machine. Through the extrusion process at the mold's head 154, the substrate with a certain thickness is obtained. After the modulation by the rolls 155, the thickness can be adjusted. After that, the surface structure is formed on one surface or both above and below surfaces. At last step of cooling through the cooling plate 156, the materials are solidified. The examination machines 157, 157′ can be used to examine the final product, that is the diffuser.

According to one of the embodiments of the present invention, the substrate is formed by a plurality of composite materials after repeatedly stacking in the co-extrusion procedure. The variant refractive indexes and thicknesses of the substrate formed by multiple types of high-polymer meet the condition of optical interference that cause the light polarized and reflected. Since the interference condition is seriously defined, the coating technology used for the general optical lens often require multiple layers with high and low refractive indexes, such as dozen or hundred layers. In the present invention, the diffuser can increase the reflectivity of polarized light by producing multiple times of interfered reflection through the multiple layers with high and low refractive indexes. That will be like the mentioned interference made by plural films.

The diffuser will have better reflectivity to a certain wavelength when the substrate has more layers stacked and better evenness control for higher variations of the refractive indexes. The asymmetric light diffuser of the present invention adopts a multi-layer co-extrusion process to implement high diffusivity and the condition with high polarization-scattering reflectivity. The materials with high variation of refractive indexes and birefringence will be used, such as PET, PEN or blended with the related high-polymeric materials.

The current embodiment repeatedly stacks the PET and PEN materials to form an (AB)ⁿ structure in the co-extrusion process. In which, n is an integer which is ranged within 10 to 500 based on the design, and the preferred value is within 120 through 180. When the temperature in the stretch procedure is controlled just as the anisotropy of the birefringence of the material happens, that is to make the refractive indexes of anisotropic and isotropic films change, and meanwhile the thickness with one-quarter wavelength is also employed, it is to accomplish the interference of multi-layer. The s-polarization of the light will be reflected, and the light consumed and absorbed by the polarization plate on the LCD panel can be efficiently recycled. Therefore, it is the object to design the diffuser with polarization-scattering reflectivity, in order to enhance the luminance of the panel.

Since the manufacturing method is difficultly to make the interference and reflection, the present invention provides a method to reach the serious requirements. In particular, if the quantity of diffusing beads used for alignment is plenty, and the stacked layers are enough, the diffuser made by the present invention can reach the requirements after producing the anisotropic characteristics in the stretch process. Therefore, the condition of the polarization and reflection of the incident light is apparent.

The mentioned reflection is not caused by the film interference, but simply the multiple times of reflectivity made by the variations of the refractive indexes among the multiple layers and materials. More particularly, the refractive indexes among the medium and the interfaces between the layers become higher variations and more complicated under the co-extrusion process. The present invention can increase the diffusivity of the diffuser since the transparent beads increase and the anisotropy of the refraction meets the function of partial polarization-scattering reflectivity.

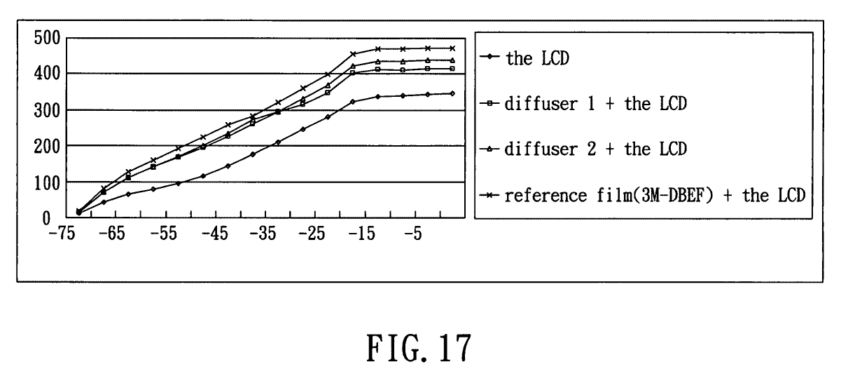

Reference is made to FIG. 17 showing a comparative diagram between the embodiment of multi-layer diffuser using co-extrusion process and the currently-sold diffuser.

Four curves shown in the diagram separately represent luminance in different view angles as the light propagating through an LCD, the LCD using the diffuser 1 of the present invention, the LCD using the diffuser 2, and the LCD using DBEF made by 3M corporation. According to the comparative result, the luminance distribution of the vertical view angle in 15-inch panel is measured by luminance-meter, a model of Topcon BM-7 FAST.

The unit in the horizontal axis of the coordinate is degree of angle, and the unit in the vertical axis is nits, the unit of luminance. The figure particularly shows there is an apparent effect of luminance enhancement using the DBEF made by 3M corporation. The figure also shows that the claimed diffuser made by the co-extrusion process has great effect to enhance luminance. More, the luminance difference between the curve related to the diffuser 1 and the curve related to the diffuser 2 is due to the variation caused by the refractive index changed by the stretch process.

Moreover, the figure shows an average of a luminance gain in every view angle is about 1.1 to 1.7, in which the average is obtained by comparing the average as the claimed diffuser is added on the backlight module and the average without the diffuser. Further, the vertical distribution does not change much in this embodiment.

As a whole, if the multi-layer co-extrusion procedure is used with the transparent diffusing beads used in some layers, the extrusion process and the stretch process can enhance variation of the refractive indexes. Therefore the polarization-scattering reflectivity caused by the variation of anisotropic refractive index can be efficiently enhanced.

In practice, when the light propagates through the diffuser, the surface structure will generate various refractive and scattering lights. Since the substrate and inside beads have anisotropic characteristic after stretching, the substrate can provide better diffusivity and enhance the anisotropy and certain effect of polarization scattering.

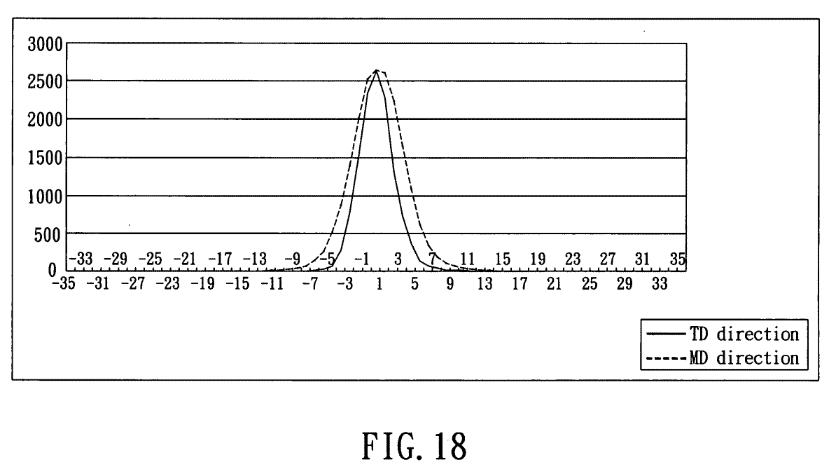

FIG. 18 shows the diffusing angles of the asymmetric diffuser along TD and MD directions of the present invention. Especially the diffuser is made by a luminosity meter as the model GC5000L made by Nippon Denshoku Industries Co., LTD. The luminosity meter shows the difference of diffusing angle along the TD and MD directions. The optical film of the current embodiment made by extrusion procedure employs a sand-blasting and etching process to produce the rolls with mist surface having micro-structure as a mold. The method is then to melt and masticate the high-polymer plastic. Next, the material is extruded by a separator through a multi-layer co-extruding machine. The produced substrate has micro-structure surface whose roughness is about 3.5 um to 5.2 um. The thickness of the film is about 0.4 mm. The film is then heated to 120 degree in a baking oven at an experimental stretcher, and obtaining a stretching ratio with 1.75. Particularly the procedure is under a monoaxial stretching. At last, the film goes through a thermal treatment to eliminate the inner stress force. The asymmetric optical film has 2 to 3 degrees FWHM angular variation along the TD and MD directions. It is noted that bigger asymmetric angular difference requires larger stretching ratio.

The general thickness of the above-described diffusing device, such as the diffuser, is about 50 um to 500 um. The thickness of the substrate can be adjusted in the extrusion procedure based the need. The film can be adhered to some other substrates in order to form a composite diffusing plate. The thickness of the general diffusing plate is about 1 mm to 9 mm. The thickness of diffusing plate used for LCD TV can be 0.5 mm to 3 mm based on the requirement. When the light diffuser is used for the diffusing plate, the mechanical strength of the support is in consideration. Alternatively, the thickness can be increased as changing the space of the rolls in the extrusion process, and the thicker diffusing plate reaches the thickness about 0.5 mm to 3 mm.

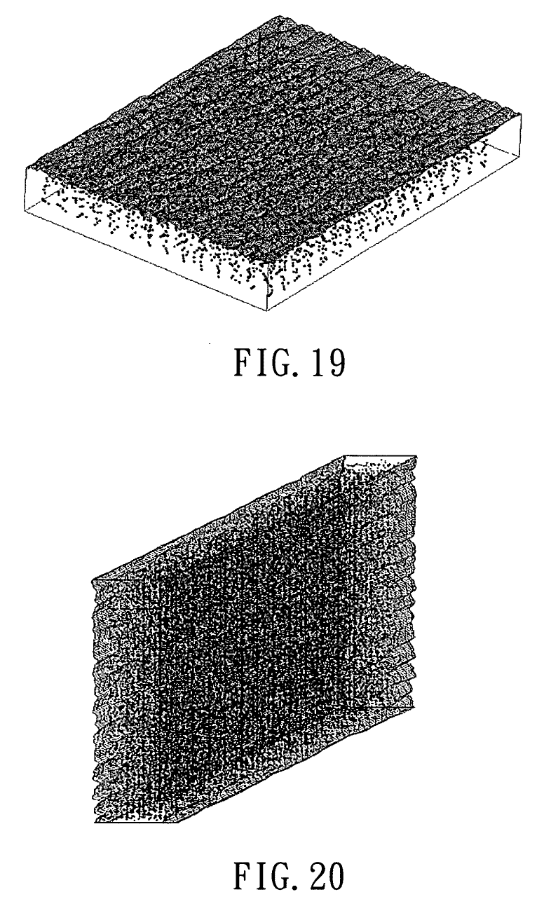

FIG. 19 is one of the structural diagrams of the light diffuser of the present invention. One surface of the substrate has an asymmetric light diffusing film with relief structure. Besides the surface structure, the transparent diffusing beads are inside the substrate. The whole substrate goes through the stretch process.

FIG. 20 is another structural diagram of the light diffuser whose above and below surfaces having relief structure of the present invention. The transparent diffusing beads are inside the substrate which is under a stretch process.

The substrate of the asymmetric light diffuser of the present invention generally goes through the stress-stretch process. The inside beads can be implemented by spherical, elliptic, non-spherical, bar-shaped, cylindrical, prismatic, or the beads blended with every shape. The surface of the substrate has surface structure made by the mold or rolls having surface structure, and co-extrusion procedure using rolls. The mold has its own surface structure which is made by sandblasting, etching, laser writing, diamond cutting, LIGA, or a surface doping process. The shape of the micro-structure of the mold can be made by further processing and have many types. The shape can be semi-sphere, pyramid, cone, ellipse, diamond, non-sphere or the shape blended with the foregoing types. After the extrusion process and the stress-stretch process, the shape of the micro-structure can be adjusted by using different stretch ratio. If the process operated with the monoaxial or multiaxial stretch process with the same or different ratios, some more asymmetric surface micro-structure that can not easily be made by the traditional mechanical processing can be produced. For example, the diffuser or diffusing plate with randomly distributed or strip-distributed micro-structure can be made.

More particularly, the rolling mode is used to produce the asymmetric structure with many proportions under a stretch process at only one time. The claimed method can reduce the molding time and the cost, in order the enhance the productivity.

To sum up the above description, the asymmetric light diffuser and its manufacturing method provided by the present invention have the following features:

(1) The substrate through the stress-stretch process can be adjusted in condition of stretching ratio, that is to modulate the size, the alignment direction, and diffusivity of the asymmetric light diffuser.

(2) The birefringence effect made by the stress-stretch process can make the variation of refractive index larger, if the birefringence is used with the micro-structure, a high-asymmetric diffusivity can be made.

(3) The isotropic beads in the substrate can be stretched to produce the birefringence effect, and also the distribution of the beads can be modulated. The birefringence may be produced as modulating the direction thereof.

(4) The molding method in the present invention needs not very complicated technology. It simplifies development of the mold and reduces the cost. The method speeds up the process to make the mold.

(5) The co-extrusion procedure has no the traditional sol coating, heating or optical solidification process to make the film. The traditional process has drawback of peeling between the substrate and the sol. The structure under the extrusion process is strengthened, and not easy warping. The micro-structure is not made by coating, therefore it is not easy to be separated from the substrate.

(6) The stretch process can be used to produce monoaxial, monoaxial constraint, or biaxial stretching effect, and applicable to one-dimensional or two-dimensional anisotropic diffusion.

(7) Since the substrate and inside beads are stretched, and operated with the suitable refractive index and thickness, the polarization-scattering reflectivity can be formed, in order to enhance the transmittance and luminance of the LCD panel.

The above-mentioned descriptions represent merely the preferred embodiment of the present invention, without any intention to limit the scope of the present invention thereto. Various equivalent changes, alternations or modifications based on the claims of present invention are all consequently viewed as being embraced by the scope of the present invention.

What is claimed is:

1. A method for manufacturing an asymmetric light diffuser, comprising:
forming a surface structure of a plate mold or a roll on a substrate's surface by a roll-to-roll extrusion process, wherein the substrate is formed by polymer material blended with transparent diffusing beads; and
performing a stretch process for stretching the substrate and a plurality of transparent beads in the substrate, so as to form a deformation of surface micro-structure;
wherein the substrate or the inside transparent beads has a refraction or an alignment, and a birefringence characteristic after the stretch process.

2. The method of claim 1, wherein the surface of the plate mold has relief structure, which is formed by a spraying method.

3. The method of claim 1, wherein the surface of the plate mold has relief structure, on which a laser is used to form the relief structure.

4. The method of claim 1, wherein the surface of the plate mold has relief structure, which is formed by an etching process.

5. The method of claim 1, wherein the surface of the plate mold has relief structure, on which a diamond blade is mechanically used to form the relief structure.

6. The method of claim 1, wherein the roll-to-roll process is used to form one surface's structure of the substrate through a set of rolls covered with the mold.

7. The method of claim 1, wherein the roll-to-roll process is used to form the surface structure on two surfaces of the substrate through a plurality of sets of the rolls with micro-structure.

8. The method of claim 1, wherein the stretch process is used to form the deformation of the micro-structure through two sets of rolls with two different rolling rates to be adjusted.

9. A method for manufacturing an asymmetric light diffuser, by which a light diffuser with characteristics of birefringence and asymmetric diffusion is manufactured, comprising:
preparing a plate mold or a roll, wherein surface of the plate mold or the roll has relief structure, so as to make a mold required to form the surface structure of the asymmetric light diffuser;
providing a substrate blended with a plurality of transparent beads;
performing a roll-to-roll process to form the surface structure of the mold on the substrate through plural sets of rolls having surface micro-structure; and
performing a stretch process to form a deformation due to the substrate and the inside transparent beads subject to the variant stresses.
wherein the substrate has refraction or structure alignment, and the characteristic of birefringence after the substrate or the inside transparent beads is stretched.

10. The method of claim 9, wherein the relief structure on the surface of the mold is formed by spraying.

11. The method of claim 9, wherein the relief structure of the mold's surface is made by a laser forming the relief texture thereon.

12. The method of claim 9, wherein the relief structure on the surface of the mold is formed by a laser process or an etching process.

13. The method of claim 9, wherein the stretch process adjusts a stretch ratio of a stretcher to deform the substrate and the inside transparent beads under the stress-stretch process.

14. The method of claim 9, wherein the stretch process deforms the substrate and the inside transparent beads under variant stresses by adjusting rolling rates of plural sets of rolls.

15. An asymmetric light diffuser, comprising:
a transparent high-polymer substrate;
a plurality of transparent diffusing beads, which are blended in the substrate as manufacturing the diffuser; and
single or double surfaces with asymmetric relief structure of the diffuser;
wherein the light diffuser with polymer substrate blended with transparent diffusing beads has relief structure surface under a stretch process, and the surface structure has asymmetric and non-axisymmetric diffusion characteristics.

16. The diffuser of claim 15, wherein the surface structure of the diffuser is formed through an extrusion process.

17. The diffuser of claim 16, wherein the extrusion process is used mold the surface structure on single or double surfaces of the light diffuser through plural sets of rolls with surface micro-structure.

18. The diffuser of claim 17, wherein the beads inside the diffuser and the surface micro-structure of the substrate are deformed by variant stresses by adjusting rolling rates of the plural sets of rolls.

19. The diffuser of claim 15, wherein the transparent diffusing beads in the diffuser have birefringence characteristic after the stretch process.

20. The diffuser of claim 19, wherein the transparent diffusing beads are isotropic, and the beads become anisotropic after the stretch process.
